(19) United States
(12) Patent Application Publication
(10) Pub. No.: US 2017/0275063 A1
(43) Pub. Date: Sep. 28, 2017

(54) BEVERAGE DISPENSING DEVICE

(71) Applicant: Epoca International Inc., Boca Raton, FL (US)

(72) Inventors: Brian Melzer, Boca Raton, FL (US); Matthew L. Chin, New York, NY (US); Stephen Kaes, New York, NY (US)

(73) Assignee: Epoca International Inc., Boca Raton, FL (US)

(21) Appl. No.: 15/467,447

(22) Filed: Mar. 23, 2017

Related U.S. Application Data
(60) Provisional application No. 62/312,244, filed on Mar. 23, 2016.

(51) Int. Cl. B65D 47/24; B01D 29/11; B65D 51/24; F16K 1/14; B65D 25/28

(52) U.S. Cl. CPC B65D 47/249; F16K 1/14; B65D 25/2811; B65D 51/249; B01D 29/11

(57) ABSTRACT

According to one example, a beverage dispensing device includes a beverage vessel configured to hold a beverage within the beverage vessel. The beverage vessel has a hole that extends entirely through a bottom portion of the beverage vessel. The beverage dispensing device further includes a plug seat located within the beverage vessel and positioned around the hole, and a weighted plug located within the beverage vessel and positioned against the opening in the plug seat. The weighted plug and plug seat are configured to prevent the beverage from draining through the hole by creating a liquid-tight seal. The beverage dispensing device further includes a lever coupled, at least indirectly, to the beverage vessel. The lever is configured, when activated, to move the weighted plug in relation to the plug seat so as to break the liquid-tight seal. The weighted plug is securely coupled to the lever.

### CROSS-REFERENCE TO RELATED APPLICATIONS

This application claims the benefit of priority to U.S. Provisional Patent Application No. 62/312,244, filed Mar. 23, 2016, the entirety of which is incorporated herein.

### TECHNICAL FIELD

This disclosure relates generally to the field of beverages and more specifically to a beverage dispensing device.

### BACKGROUND

Traditionally, a user has created a beverage (such as tea) using a beverage creation device (such as a pitcher), and then the user has traditionally tipped the beverage creation device over in order to pour the created beverage out into a cup. Such traditional beverage creation devices, however, may be deficient.

### SUMMARY

According to one example, a beverage dispensing device includes a beverage vessel configured to hold a beverage within the beverage vessel. The beverage vessel has a hole that extends entirely through a bottom portion of the beverage vessel. The beverage dispensing device further includes a plug seat located within the beverage vessel and positioned around the hole, and a weighted plug located within the beverage vessel and positioned against the opening in the plug seat. The weighted plug and plug seat are configured to prevent the beverage from draining through the hole by creating a liquid-tight seal. The beverage dispensing device further includes a lever coupled, at least indirectly, to the beverage vessel. The lever is configured, when activated, to move the weighted plug in relation to the plug seat so as to break the liquid-tight seal. The weighted plug is securely coupled to the lever.

Certain embodiments of the disclosure may provide one or more technical advantages. For example, the weighted plug may be securely coupled to the lever. This secure coupling may prevent the weighted plug from rolling around inside of the beverage vessel, or from becoming lost (such as if a user were to misplace an unsecured weighted plug), in some examples.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIGS. 1A-1C illustrate an example beverage dispensing device.

FIGS. 2A-2E illustrate further views of the beverage dispensing device of FIGS. 1A-1C.

FIG. 3 illustrates various views of another example beverage dispensing device.

FIG. 4 illustrates various views of a beverage vessel of another example beverage dispensing device.

### DETAILED DESCRIPTION

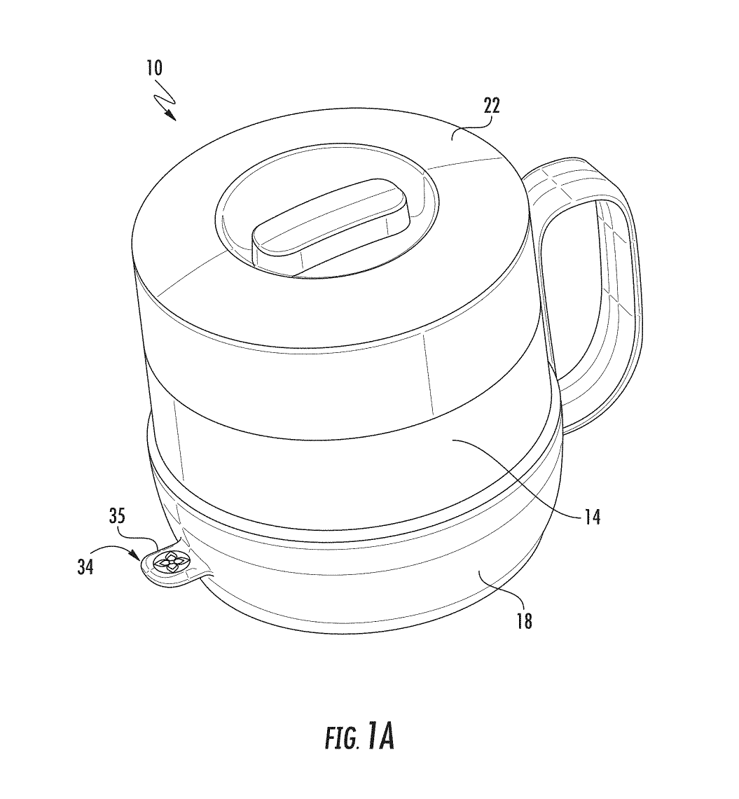

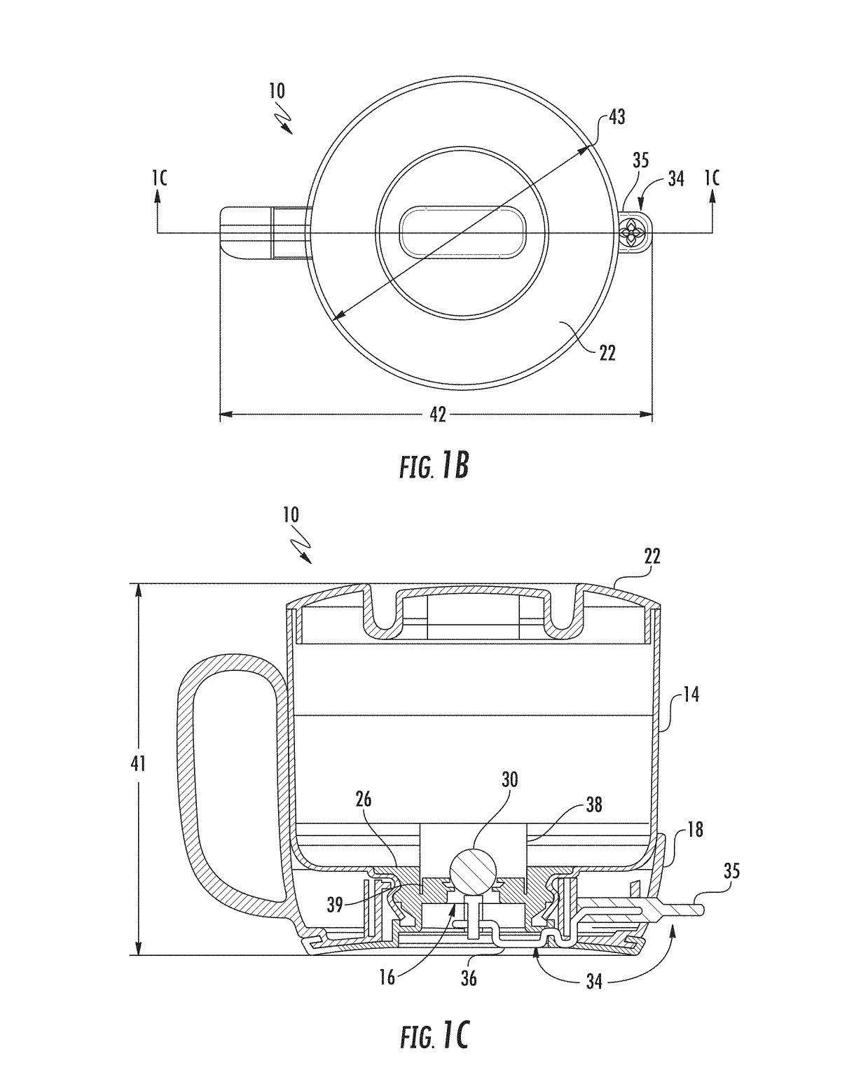

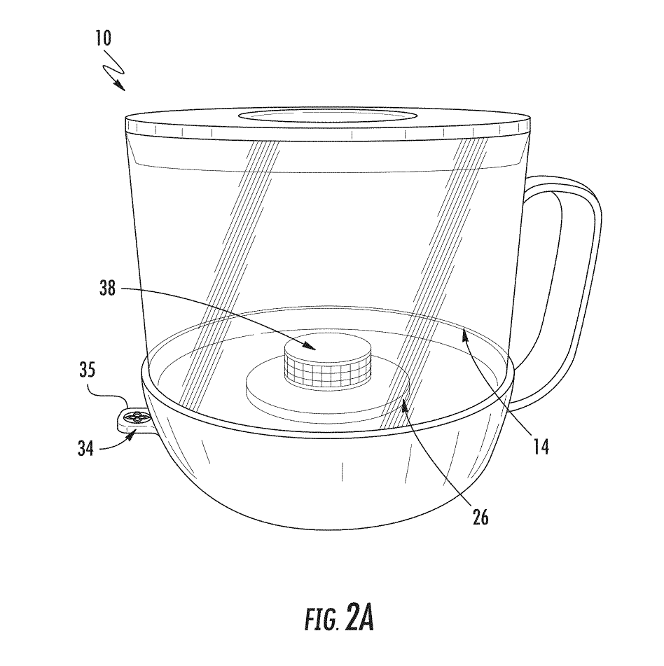

Embodiments or examples of the present disclosure are best understood by referring to FIGS. 1A-4 of the drawings, like numerals being used for like and corresponding parts of the various drawings.

FIGS. 1A-1C illustrate an example beverage dispensing device. For example, FIG. 1A is a perspective view of an example beverage dispensing device 10; FIG. 1B is a top view of the example beverage dispensing device 10 of FIG. 1A; and FIG. 1C is a cross-sectional view of the example beverage dispensing device 10 of FIG. 1B taken at section line 1C of FIG. 1B.

The beverage dispensing device 10 may allow a beverage to be brewed (or otherwise created), and may further allow the beverage to be dispensed. For example, ingredients for a beverage may be inserted into the beverage dispensing device 10 for brewing. Following the brewing of the beverage, the beverage dispensing device 10 may be used to dispense the beverage into, for example, a mug, a cup, or any other beverage holder.

As illustrated, the beverage dispensing device 10 includes a beverage vessel 14. The beverage vessel 14 may be any vessel that may hold a beverage. For example, the beverage vessel 14 may be a container, a pitcher, a carafe, any other vessel that may hold a beverage, or any combination of the preceding. The beverage vessel 14 may have any shape and/or size. For example, the beverage vessel 14 may be sized to hold 1 quart of a beverage, 2 quarts of a beverage, 1 gallon of a beverage, 2 gallons of a beverage, 5 gallons of a beverage, or any other amount of a beverage. The beverage vessel 14 may be made of any material that may hold a beverage. For example, the beverage vessel 14 may be made of metal, glass, plastic, a polymer, any other material that may hold a beverage, or any combination of the preceding. As illustrated, the beverage vessel 14 is made of glass.

In some examples, the beverage vessel 14 may be opaque. In other examples, the beverage vessel 14 may be transparent (or at least partially transparent), thereby allowing a user to view one or more contents of the beverage vessel 14, such as the beverage, the ingredients of the beverage, one or more portions of the beverage dispensing device 10, or any combination of the preceding. In some examples, the transparency of the beverage vessel 14 may allow a user to visually determine when the beverage is finished being brewed (or otherwise created). The transparency of the beverage vessel 14 may include any amount of total transmittance.

As is discussed above, the beverage vessel 14 may hold a beverage. The beverage may be any type of liquid that may be consumed. For example, the beverage may be coffee, tea, soda, a fruit-based drink (such as lemonade, orange infused water, pineapple infused water, etc.), a vegetable-based drink (such as cucumber infused water, etc.), any other type of liquid that may be consumed, or any combination of the preceding.

The beverage vessel 14 may hold the beverage while the beverage is being brewed (such as immersion brewed) or otherwise created in the beverage vessel 14. For example, when the beverage is coffee, the beverage vessel 14 may hold hot water and coffee grounds (and/or any other ingredients), thereby allowing the coffee to be brewed for consuming. As another example, when the beverage is tea, the beverage vessel 14 may hold hot water and tea leaves (and/or any other ingredients, such as lemon), thereby allowing the tea to be brewed for consuming As another example, when the beverage is cucumber infused water, the beverage vessel 14 may hold cold water and cucumber pieces (and/or any other ingredients), thereby allowing cucumber infused water to be created for consuming.

In addition to brewing the beverage, the beverage vessel 14 may allow the beverage to be modified in any way while being held in the beverage vessel 14. For example, a beverage may be brewed in the beverage vessel 14 (or an already brewed or created beverage may be added to the beverage vessel 14), and then ice may be added to the beverage vessel 14 in order to cool the beverage for consuming. As another example, a beverage may be brewed in the beverage vessel 14 (or an already brewed or created beverage may be added to the beverage vessel 14), and then sugar (or any other ingredient) may be added to the beverage vessel 14 in order to modify the beverage for consuming.

To dispense the beverage, the beverage vessel 14 may include a hole 16 (seen in FIG. 1C) positioned at (or near) the bottom of the beverage vessel 14. The hole 16 may extend entirely through a portion of the beverage vessel 14, thereby providing an entry point (on the inside of the beverage vessel 14) in fluid communication with an exit point (outside of the beverage vessel 14). The hole 16 may allow a beverage to be dispensed out of the beverage vessel 14 after, for example, the beverage has been brewed (or otherwise created). The hole 16 may have any size and/or shape. For example, the hole may be a circular hole, an oval hole, a square hole, any other shaped hole, or any combination of the preceding.

The hole 16 may extend through the beverage vessel 14 at any orientation. For example, the hole 16 may extend through the beverage vessel 14 in a vertical orientation, thereby allowing the beverage to be dispensed vertically. As another example, the hole 16 may extend through the beverage vessel 14 at a vertical slant, such as at a 45° slant. In such an example, the beverage may be dispensed out of the beverage vessel 14 at the vertical slant, which may further prevent splashing of the dispensed beverage.

The beverage dispensing device 10 may further include a base 18 and a lid 22. The base 18 may be any structure that may support and/or hold (or otherwise provide a base for) the beverage vessel 14. The beverage vessel 14 may be coupled to (or positioned within) the base 18, and then the base 18 may hold the beverage vessel 14 in an upright orientation, as is illustrated in FIGS. 1A-1C. As such, the base 18 may increase the stability of the beverage dispensing device 10. Furthermore, as is discussed below, the base 18 may couple a lever 34 to the beverage vessel 14. The beverage vessel 14 may be coupled to the base 18 in any manner that allows the base 18 to support and/or hold (or otherwise provide a base for) the beverage vessel 14. For example, the base 18 and/or the beverage vessel 14 may have grooves or threads that may allow the beverage vessel 14 to be screwed into the base 18, as is seen in FIG. 4. As another example, the base 18 may have slots or clips that may allow the beverage vessel 14 to be clipped (or snapped) into the base 18. As a further example, the beverage vessel 14 may be coupled to the base 18 using an adhesive (such as glue) or one or more connectors, such as screws.

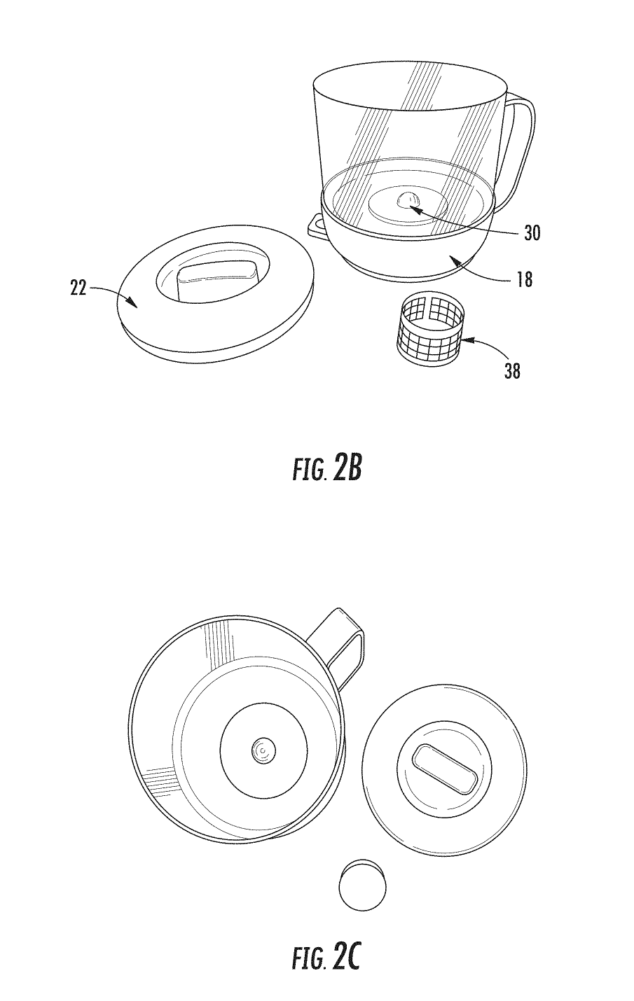

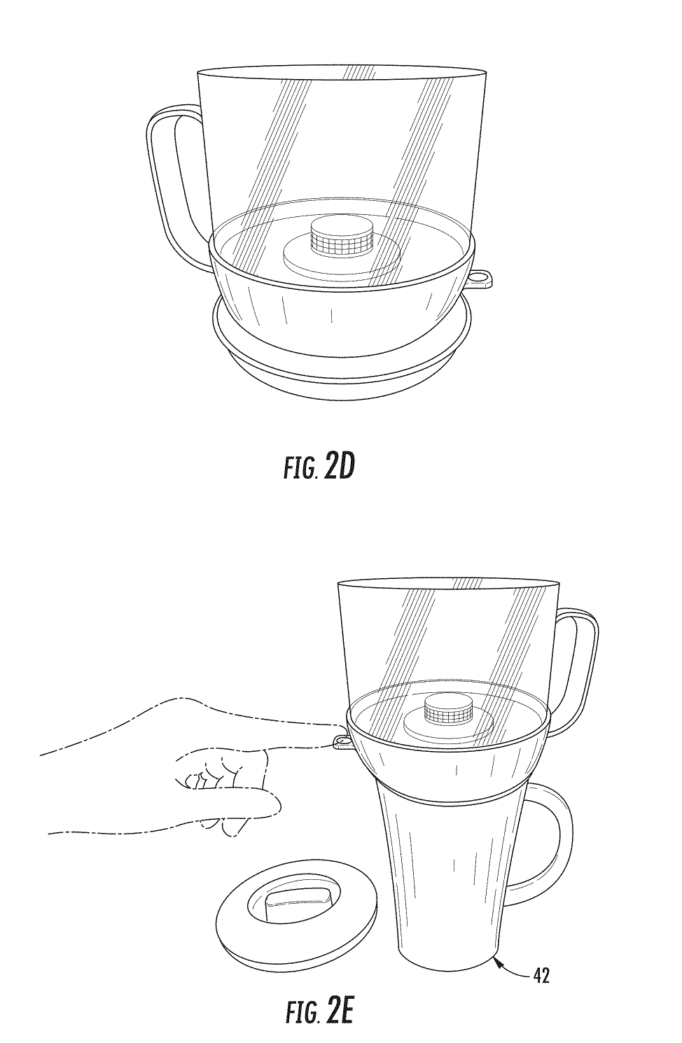

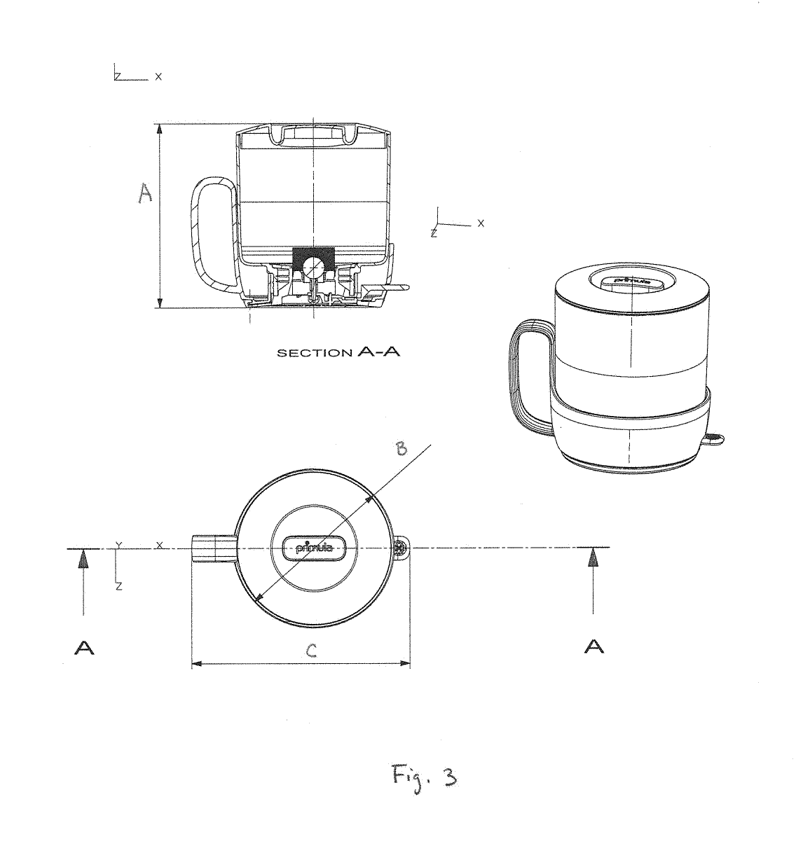

The base 18 may further allow the beverage dispensing device 10 to be positioned on top of a beverage cup 42 (such as a glass, a cup, a mug, any other container that may hold a beverage after the beverage is dispensed from the beverage dispensing device 10, or any combination of the preceding). In such an example, the base 18 may be placed on top of the beverage cup 42 (an example of which is seen in FIG. 2E), and the base 18 may support the entire beverage dispensing device 10 on top of the beverage cup 42. This may allow the beverage dispensing device 10 to dispense the beverage into the beverage cup 42 while the beverage dispensing device 10 is positioned on the beverage cup 42.

The base 18 may have any size and/or shape. Additionally, as is illustrated in FIGS. 1A-1C, the base 18 may include a handle. This handle may allow a user to pick up (and or move) the beverage dispensing device 10. The base 18 may be made of any material. For example, the base 18 may be made of metal, glass, plastic, a polymer, any other material, or any combination of the preceding. As illustrated, the base 18 is made of plastic.

The lid 22 may be any structure that may be positioned on the top of the beverage vessel 14 in order to seal off (completely or partially) the top of the beverage vessel 14. As such, the beverage dispensing device 10 may be moved without spilling the beverage (or reducing the chance of spilling the beverage) out of the top of the beverage vessel 14. Additionally, the lid 22 may prevent one or more contaminants from entering the beverage vessel 14 (or reduce the chance of one or more contaminates entering the beverage vessel 14) while the lid 22 is positioned on the beverage vessel 14. The lid 22 may have any shape and/or size that allows the lid 22 to be positioned on the top of the beverage vessel 14 in order to seal off the top of the beverage vessel 14. For example, the lid 22 may have a circular shape, an oval shape, a square shape, any other shape, or any combination of the preceding. In some examples, the shape and/or size of a portion of the lid 22 may match the interior shape of the top of the beverage vessel 14. As such, the portion of the lid 22 may fit into the top of the beverage vessel 14.

In some examples, the lid 22 may further be shaped to be used as a coaster (or holder) for the beverage dispensing device 10. For example, the lid 22 may have a shape and/or size that fits into (or otherwise attaches to) the bottom of the base 18. As such, the base 18 may be positioned on top of the lid 22, which may allow the lid 22 to operate as a coaster (or holder) for the beverage vessel 14 (an example of which is seen in FIG. 2D). Additionally, the lid 22 may be made of any material. For example, the lid 22 may be made of metal, glass, plastic, a polymer, any other material, or any combination of the preceding. As illustrated, the lid 22 is made of plastic.

The beverage dispensing device 10 further includes a plug seat 26 and a weighted plug 30 which may collectively seal the hole 16 of the beverage vessel 14. This may prevent the beverage from draining through the hole 16 prior to being dispensed. The plug seat 26 may be any structure that may operate in cooperation with the weighted plug 30 to provide a liquid seal (such as to provide a pressure or weight-based liquid-tight seal). For example, the plug seat 26 may be a hollow seat that the weighted plug 30 can rest upon (or otherwise be positioned against) so as to provide a liquid seal. In such an example, the weighted plug 30 may rest upon (or otherwise be positioned against) an opening in the top of the plug seat 26, thereby causing the weighted plug 30 to block off (or otherwise seal) access to the opening in the plug seat 26. As other examples, the plug seat 26 may be a gasket, a liner, a washer, any other structure that may operate in cooperation with the weighted plug 30 to provide a liquid seal, or any combination of the preceding. As is illustrated in FIG. 1C, the plug seat 26 is a hollow seat. In such an example, when the weighted plug 30 is resting upon (or otherwise positioned against) the plug seat 26 (and/or the opening in the plug seat 26), the plug seat 26 and the weighted plug 30 may collectively seal up access to the hole 16. As such, the beverage may not be able to enter the hole 16 and exit the beverage vessel 14 through the hole 16. Alternatively, when the weighted plug 30 is moved away from the plug seat 26 (as is discussed below in detail), the beverage may be able to flow past the weighted plug 30, flow into the opening in the plug seat 26, flow into the hollow center of the plug seat 26, and enter the hole 16 so as to exit the beverage vessel 14 through the hole 16.

The plug seat 26 may be located within the beverage vessel 14 and may be positioned around the hole 16. The plug seat 26 may be positioned around the hole 16 in any manner For example, as is illustrated in FIG. 1C, the plug seat 26 may entirely surround the circumference of the hole 16 and may also extend into (and, in some examples, through) the hole 16. In such an example, the plug seat 16 may line all or a portion of the passageway through the hole 16. In some examples of this, the plug seat 26 may extend entirely through the hole 16 and also form a bottom layer of the base 18 (by attaching to the base 18, for example), as is illustrated in FIG. 1C. As another example, the plug seat 26 may entirely surround the circumference of the hole 16, but may not extend through the bottom portion of the beverage vessel 14. Instead, the plug seat 26 may form a ring (or other shape) around the hole 16 at a location that is level with (or vertically above) an entry point of the hole 16. This ring (or other shape) around the hole 16 may have an inner circumference (or other dimension) that may touch the outer circumference of the entry point of the hole 16. Alternatively, this ring (or other shape) around the hole 16 may have an inner circumference (or other dimension) that may not touch the outer circumference of the entry point of the hole 16. Instead, there may be spacing (such as a spacing of at least 1 millimeter) between the inner circumference of the ring and the outer circumference of the entry point of the hole 16 (creating a gap between the hole 16 and the plug seat 26).

By being positioned around the hole 16, the beverage in the beverage dispensing device 14 may be forced to pass by or through at least a portion of the plug seat 26 prior to entering the hole 16. For example, the beverage may be forced to pass through an opening (and/or passageway) in the plug seat 26 prior to entering the hole 16. Therefore, if the opening in the plug seat 26 is sealed off by the weighted plug 30, the beverage may be unable to access the hole 16. The plug seat 26 and the weighted plug 30 may create a liquid-tight seal (or water-tight seal) that may prevent any portion of the beverage from leaking through the hole 16 prior to being dispensed.

The plug seat 26 may have any size and/or shape that may allow it to operate in cooperation with the weighted plug 30 to seal off the hole 16 of the beverage vessel 14. Additionally, the plug seat 26 may be made of any material that may allow it to operate in cooperation with the weighted plug 30 to seal off the hole 16 of the beverage vessel 14. For example, the plug seat 26 may be made of rubber, plastic, a polymer, any other material that may allow it to operate in cooperation with the weighted plug 30 to seal off the hole 16 of the beverage vessel 14, or any combination of the preceding. As illustrated, the plug seat 26 is made of silicone.

As is discussed above, the plug seat 26 may operate in cooperation with the weighted plug 30 to seal off the hole 16 of the beverage vessel 14. The weighted plug 30 may be any structure that may rest upon (or otherwise be positioned against) the plug seat 26 (and/or an opening in the plug seat 26) so as to seal off the hole 16 and prevent the beverage from draining through the hole 16. For example, the weighted plug 30 may be a plug, a cover, a weight, any other structure that may rest upon (or otherwise be positioned against) the plug seat 26 (and/or an opening in the plug seat 26) so as to seal off the hole 16, or any combination of the preceding.

The weighted plug 30 may be positioned adjacent to the plug seat 26. As is illustrated, the weighted plug 30 may be located within the beverage vessel 14 in a location vertically over the plug seat 26 and the hole 16. This positioning may cause the weighted plug 30 to rest upon the plug seat 26 when the weighed plug 30 is moved vertically down onto the plug seat 26. In other examples, the weighted plug 30 may be located within the beverage vessel 14 in a location horizontally off-center from the plug seat. Such positioned may cause the weighted plug 30 to rest upon the plug seat 26 when the weighted plug 30 is moved horizontally over the plug seat 26. In some examples, by resting against (or being positioned against) the plug seat 26 (and/or an opening in the plug seat 26), the weighted plug 30 may close off the beverage's access to the hole 16.

The weighted plug 30 may have any shape and/or size. For example, the weighted plug 30 may be shaped as a ball, a funnel, a ball having a bottom portion that is shaped as a funnel or stick (e.g., an ice cream and ice cream cone shape), any other shape, or any combination of the preceding. As is illustrated in FIGS. 1A-1C, the weighted plug 30 is shaped as a ball having a bottom portion (e.g., a connection piece) that is shaped as a funnel or stick (e.g., an ice cream and ice cream cone shape). Such a shape allows the weighted plug 30 to be securely coupled to the lever 34 (as is discussed below), as it allows the weighted plug 30 to extend through the hole 16 to be securely coupled to an internal end 36 of the lever 34.

The shape of the weighted plug 30 may cause the weighted plug 30 to fill (or otherwise plug) the opening in the plug seat 26 (which may provide access to the hole 16) and/or fill the entry point of the hole 16. As such, when the weighted plug 30 is resting upon (or otherwise positioned against) the plug seat 26 (and/or the opening in the plug seat 26), the weighted plug 30 may fill (all or a portion) of the opening in the plug seat 26 and/or all of the entry point of the hole 16, which may create a liquid-tight seal. Furthermore, the weighted plug 30 may have a size that is greater than the size of the opening in the plug seat 26 and/or the size of the entry point of the hole 16. This may allow the weighted plug 30 to completely cover the opening in the plug seat 26 and/or the entry point of the hole 16.

The weighted plug 30 may be made of any material that may rest upon (or otherwise be positioned against) the plug seat 26 (and/or the opening in the plug seat 26) so as to seal off the hole 16 and prevent the beverage from draining through the hole 16. For example, the weighted plug 30 may be made of metal, glass, rubber, plastic, a polymer, any other material that may rest upon (or otherwise be positioned against) the plug seat 26 so as to seal off the hole 16 and prevent the beverage from draining through the hole 16, or any combination of the preceding. As illustrated, the weighted plug 30 is made of metal, such as stainless steel.

The weight of the weighted plug 30 may cause the weighted plug 30 to press down against the plug seat 26 when the weighted plug 30 is resting upon (or otherwise positioned against) the plug seat 26. In some examples, as is discussed below, the weighted plug 30 may rest upon (or otherwise be positioned against) the plug seat 26 when the lever 34 is not activated, as is discussed below. By pressing down against the plug seat 26 (and/or the opening in the plug seat 26), the weighted plug 30 and the plug seat 26 may collectively form a seal that prevents the beverage from draining through the hole 16.

In addition to creating a seal that may prevent the beverage from draining through the hole 16, the weighted plug 30 may also be used to unseal the hole 16 to allow the beverage to be dispensed when desired by a user. For example, the weighted plug 30 may be moved vertically upward in relation to the plug seat 26 (or otherwise dislodged from the plug seat 26). This upward movement may break the seal (or otherwise provide a hole, gap, or opening in the seal) created by the weighted plug 30 and plug seat 26, and may allow the beverage to drain through the hole 16. The upward movement (or any other movement) of the weighted plug 30 may be caused by the lever 34, as is also discussed below.

As is illustrated, the beverage dispensing device 10 further includes the lever 34. The lever 34 may be any structure and/or device that may cause the weighted plug 30 to move, such as move away from the plug seat 26. In particular, the lever 34 may be any structure and/or device that may cause the weighted plug 30 to move upward in relation to the plug seat 26 (so as to break the seal and allow the beverage to be dispensed), and that may further allow (or cause) the weighted plug 30 to move downward in relation to the plug seat 26 (so as to create the seal, and prevent the beverage from draining through the hole 16).

The lever 34 may have any shape that allows the lever 34 to cause the weighted plug 30 to move. In some examples, the shape of the lever 34 may further be designed to cause any beverage that flows onto a portion of the lever 34 to drip off the sides of the lever 34 (as opposed to flowing along the length of the lever 34). For example, as is illustrated in FIG. 1C, the internal end 36 of the lever 34 may have a portion that dips down in height from the height at which the lever 34 is coupled to the weighted plug 30. In some examples, this dip in height may encourage liquid to drip off of the lever 34. As another example, and as is further illustrated in FIG. 1C, the internal end 36 may also have one or more portions (closer to visible end 35) that increase in height from the dip down height and/or the height at which the lever 34 is coupled to the weighted plug 30. In some examples, this may prevent liquid from flowing up and further along the lever 34 (such as toward visible end 35). Instead, the liquid may drip off the sides of the lever 34.

As is illustrated, the lever 34 may be a mechanical lever that may cause (or allow) the weighted plug 30 to move vertically up and down in relation to the plug seat 26. In such an example, the user may activate the lever 34 by pressing down on the visible (or otherwise accessible) end 35 of the lever 34. An example of such an activation is seen in FIG. 2E. This activation of the lever 34 may cause the weighted plug 30 to move vertically upward in relation to the plug seat 26. For example, such an activation may cause the internal end 36 of the lever 34 to tilt upward. As a result of the upward tilt, the weighted plug 30 may be pushed vertically upward in relation to the plug seat 26.

Additionally, the user may deactivate the lever 34 by letting go of the visible end 35 of the lever 34. This deactivation of the lever 34 may allow (or cause) the weighted plug 30 to move vertically downward in relation to the plug seat 26. In such an example, the deactivation may allow the weight of the weighted plug 30 to push the weighted plug 30 down against the plug seat 26. Alternatively, the deactivation may force the weighted plug 30 down against the plug seat 26 (or otherwise cause the weighted plug 30 to move down against the plug seat 26).

In other examples, the lever 34 may be activated and/or deactivated in any other manner For example, the lever 34 may be activated (causing the weighted plug 30 to move vertically upward) by the user pulling up on the visible end 35, and the lever 34 may be deactivated (causing the weighted plug 30 to move vertically downward to rest upon the plug seat 26) by the user releasing the visible end 35.

To move the weighted plug 30, the lever 34 is securely coupled to the weighted plug 30, in some examples. In such examples, movement of the lever 34 may be translated to the weighted plug 30 (causing and/or allowing the weighted plug 30 to move). The secure coupling may prevent the weighted plug 30 from being detached from the lever 34. As such, the weighted plug 30 and the lever 34 may be a single (or integrated) piece or unit that performs the operations of both the weighted plug 30 and the lever 34. The secure coupling may be a permanent coupling that may only detach if the coupling were to break or if the user were to physically uncouple the secure coupling.

The secure coupling may be provided in any manner. In one example, the secure coupling may be provided by welding the weighted plug 30 to the lever 34. In another example, the secure coupling may be provided by securely attaching the weighted plug 30 to the lever 34 using one or more nuts and bolts (or other attachment devices). In such an example, the secure coupling may be uncoupled by a user unscrewing the nuts and bolts. Furthermore, in such an example, the user may be able to replace the lever 34 or the weighted plug 30 separately from each other. In a further example, the secure coupling may be provided by integrally forming the weighted plug 30 with the lever 34. In another example, the secure coupling may be provided by both the weighted plug 30 and the lever 34 being securely attached to the same component (such as a rod or a linkage piece). The secure coupling of the lever 34 to the weighted plug 30 may prevent the weighted plug 30 from rolling around inside of the beverage vessel 14, or from becoming lost (such as if a user were to misplace an unsecured weighted plug), in some examples.

In some examples, the secure coupling may still allow some independent movement between the weighted plug 30 and the lever 34. For example, the secure coupling may not be rigid, so as to allow some horizontal and/or angular movement (such as unconstrained movement) between the weighted plug 30 and the lever 34. In some examples, this movement may allow the seal between the weighted plug 30 and the plug seat 26 to be formed as a result of only the weighted plug 30′s own weight (and gravitational forces). As such, the seal may be formed anytime the lever 34 is not being activated. Additionally, in some examples, this movement may also allow the seal to be unsealed when the lever 34 is activated.

The lever 34 may be coupled directly to the weighted plug 30. For example, the lever 34 may be welded directly to the weighted plug 30. Alternatively, the lever 34 may be coupled indirectly to the weighted plug 30. For example, the lever 34 may be coupled to one or more linkage pieces, and the one or more linkage pieces may be coupled to the weighted plug 30. Additionally, any portion of the lever 34 may be coupled to the weighted plug 30. For example, as is illustrated, the internal end 36 of the lever 34 may be coupled to the weighted plug 30 (either directly or indirectly).

The coupling between the weighted plug 30 and the lever 34 may be positioned in any manner with regard to the hole 16. For example, the coupling between the weighted plug 30 and the lever 34 may be positioned to extend through the hole 16, itself. In such an example, the weighted plug 30 may extend down through the hole 16 to a location where it is coupled to the lever 34, or vice versa. As such, when the beverage is dispensed from the beverage vessel 14, the beverage may travel over a portion of the coupling and/or a portion of the lever 34. Alternatively, the coupling between the weighted plug 30 and the lever 34 may extend through a separate hole or pathway in the beverage vessel 14. In such an example, the weighted plug 30 may extend through the separate hole (such as another liquid sealed hole) to a location where it is coupled to the lever 34, or vice versa. As such, when the beverage is dispensed from the beverage vessel 14, the beverage may not travel over a portion of the coupling and/or the lever 34. Instead, the beverage may only travel through the hole 16.

The lever 34 may also be coupled to the beverage vessel 14. The lever 34 may be coupled to the beverage vessel 14 in any manner For example, the lever 34 may be coupled directly to the beverage vessel 14. In such an example, the visible end 35 of the lever 34 may extend out of a portion of the beverage vessel 14. As another example, the lever 34 may be coupled indirectly to the beverage vessel 14, such as coupled to the base 18. In such an example, the visible end 35 of the lever 34 may extend out of the base 18, as is illustrated in FIGS. 1A-1C.

The lever 34 may have any shape, size, and/or configuration that may allow the lever 34 to cause the weighted plug 30 to move. Additionally, the lever 34 may be made of any material that may allow the lever 34 to cause the weighted plug 30 to move. For example, the lever 34 may be made of metal, glass, rubber, plastic, a polymer, any other material that may allow the lever 34 to cause the weighted plug 30 to move, or any combination of the preceding.

As illustrated, the lever 34 is made of metal, such as stainless steel, and the lever further includes a plastic covering at the visible end 35 of the lever 34.

The beverage dispensing device 10 may further include a filter 38. The filter 38 may be any structure that may filter the beverage. For example, the filter 38 may be (or include) a mesh filter (such as a screen) that includes openings big enough to allow liquid to pass through the filter, but small enough to prevent particles (such as tea leaves, coffee grains, food particles, non-liquid elements that have not dissolved in the beverage, etc.) from passing through the filter. The mesh filter may have any size openings. For example, the mesh filter may be a 100 micron filter, 50 micron filter, 25 micron filter, 20 micron filter, or a mesh filter with any other size openings.

The filter 38 may be located within the beverage vessel 14 and positioned around the weighted plug 30. For example, the filter 38 may cover (or otherwise encapsulate) the weighted plug 30 and the entry to the hole 16, as is seen in FIG. 1C. This may force the beverage to pass through the filter 38 before it can enter the hole 16 and be dispensed.

As is illustrated, the filter 38 may be positioned within a groove 39 in the plug seat 26. The groove 39 may have any shape and/or size. Furthermore, the groove 39 may hold the filter 38 in place in the beverage vessel 14 while the beverage is being made and while the beverage is being dispensed.

The filter 38 may be removable. For example, a user may be able to remove the filter 38 from the beverage vessel 14 to clean the filter 38. Alternatively, the filter 38 may not be removable. In an example where the filter 38 is removable, the filter 38 may be re-used for any number of brews and/or dispensing of a beverage. Alternatively, the filter 38 may be replaced with a new filter 38 for each brew and/or dispensing of a beverage.

The filter 38 may have any shape and/or size that allows the filter 38 to be positioned around the weighted plug 30. For example, the filter 38 may be shaped as a cylinder with an open end (facing downward when positioned in the beverage vessel 14) and a closed end (facing upward when positioned in the beverage vessel), as is illustrated in FIG. 1C. The open end may allow the filter 38 to be positioned in the beverage vessel 14 in a location around the weighted plug 30. The filter 38 may also be sized so that it does not interfere with the weighted plug 30. For example, the filter 38 may have a height that prevents the weighted plug 30 from contacting the filter 38 even when the weighted plug 30 is positioned at its maximum vertical height (due to activation of the lever 34).

The filter 38 may be made of any material that may allow the filter 38 to filter the beverage. For example, the filter 38 may be made of metal, rubber, plastic, a polymer, paper, any other material that may allow the filter 38 to filter the beverage, or any combination of the preceding. As illustrated, the mesh of the filter 34 is made of metal, such as stainless steel, and the frame of the filter 34 is made of plastic and/or metal.

When fully assembled, the beverage dispensing device 10 may have any size. For example, the beverage dispensing device 10 may have a height 41 of approximately 50 mm (e.g., 50 mm+/−10 mm), 100 mm, 110 mm, 115 mm, 115.3 mm, 120 mm, 150 mm, 200 mm, or any other height. As another example, the beverage dispensing device 10 may have a length 42 of approximately 50 mm (e.g., 50 mm+/−10 mm), 100 mm, 110 mm, 115 mm, 120 mm, 150 mm, 160 mm, 163.2 mm, 170 mm, 180 mm, 200 mm, or any other length. As a further example, the beverage vessel 14 of the beverage dispensing device 10 may have a diameter 43 of approximately 50 mm (e.g., 50 mm+/−10 mm), 100 mm, 105 mm, 110 mm, 115 mm, 119 mm, 120 mm, 150 mm, 200 mm, or any other diameter.

In operation, a user may add one or more ingredients to the beverage vessel 14. For example, the user may add hot water and coffee grounds to the beverage vessel 14 in order to brew (or otherwise create) coffee.

Following (or during, or before) the brewing, creation, or modification of the beverage, the beverage dispensing device 10 may be positioned on the top of a beverage cup 42 (such as a mug), as is seen in FIG. 2E. The beverage dispensing device 10 may then be used to dispense all or a portion of the beverage into the beverage cup 42.

To do so, a user may activate the lever 34, such as by pressing down on the visible end 35 of the lever 34, as is seen in FIG. 2E. In the illustrated examples, this activation may cause the internal end 36 of the lever 34 to move upward (such as tilting upward). Furthermore, the upward movement of the internal end 36 may push the weighted plug 30 (or otherwise force the weighted plug 30 to move) vertically upward in relation to the plug seat 26. As such, the weighted plug 30 may move away from its position against the plug seat 26 (and/or the opening in the plug seat 26), thereby breaking the seal and allowing the beverage to flow past the weighted plug 30, through the opening in the plug seat 26, into the entry point of the hole 16, and out of the hole 16 and into the beverage cup 42, for example.

When the user is finished dispensing all or a portion of the beverage from the beverage vessel 14, the user may stop activating the lever 34, such as by releasing the lever 34. This may cause the visible end 35 of the lever 34 to move upward, which may also cause the internal end 36 of the lever 34 to move downward (such as by tilting back downward). The downward movement of the internal end 36 of the lever 34 (and/or the weight of the weighted plug 30) may cause the weighted plug 30 to move vertically downward with respect to the plug seat 26. As such, the weighted plug 30 may once again rest upon (or otherwise be positioned against) the plug seat 26 (and/or the opening in the plug seat 26), causing the weighted plug 30 and plug seat 26 to once again collectively create a seal that prevents the beverage from draining through the hole 16.

The operation of the lever 34 and the dispensing of the beverage may occur any number of times and for any duration of time. Furthermore, although the activation of the lever 34 and the dispensing of the beverage has been described above as being performed by pressing down on the visible end 35 of the lever 34, in some examples the activation of the lever 34 and the dispensing of the beverage may be performed by lifting the visible end 35 of the lever 34, moving the visible end 35 of the lever 34 horizontally to the left and/or the right, any other movement of the visible end 35 of the lever 34, or any combination of the preceding. Additionally, although the activation of the lever 34 and the dispensing of the beverage has been discussed above as being performed mechanically, in some examples, the activation of the lever 34 and the dispensing of the beverage may be performed electronically or by any other means. For example, in some examples, a user may press an electronic button, which may cause the weighted plug 30 to move upward (or downward).

FIGS. 2A-2E illustrate further views of the beverage dispensing device 10 of FIGS. 1A-1C. FIG. 2A illustrates a perspective view of the beverage dispensing device 10. FIG. 2B illustrates a perspective view of the beverage dispensing device 10 with the lid 22 and filter 38 removed from the beverage vessel 14. FIG. 2C illustrates a top view of the beverage dispensing device 10 with the lid 22 and filter 38 removed from the beverage vessel 14. FIG. 2D illustrates a perspective view of the beverage dispensing device 10 with the lid 22 removed from the beverage vessel 14 and with the lid 22 operating as a coaster for the base 18 and beverage vessel 14. FIG. 2E illustrates a perspective view of the beverage dispensing device 10 with the lid 22 removed from the beverage vessel 14 and with beverage vessel 14 and base 14 positioned on top of the beverage cup 42, so as to allow the beverage to be dispensed into the beverage cup 42.

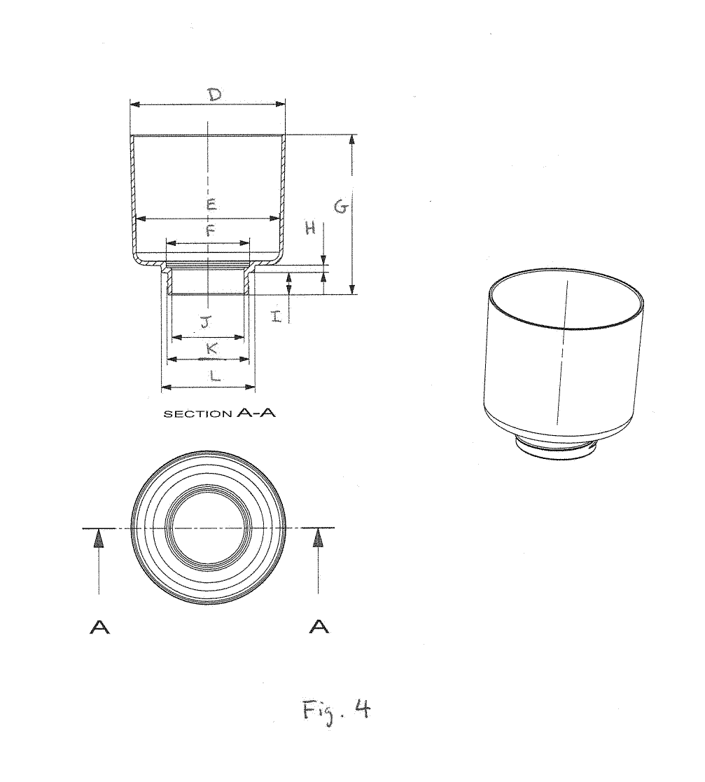

FIG. 3 illustrates various views of another example beverage dispensing device 10. The beverage dispensing device 10 of FIG. 3 may be substantially similar to the beverage dispensing device 10 of FIGS. 1-2E; however, the beverage dispensing device 10 of FIG. 3 may include a specific type of secure coupling between the weighted plug 30 and the lever 34. For example, as is illustrated, the weighted plug 30 may include a threaded rod (or any other connection piece) that is coupled to (such as, for example, by welding or by being formed integral with the weighted plug 30) to the weighted plug 30. Additionally, this threaded rod may be positioned through a hole in the lever 34, and a cap nut (or any other nut) may be coupled to the end of the threaded rod. In some examples, this may provide a secure coupling that may not be undone without one or more tools.

The beverage dispensing device 10 of FIG. 3 may have any of the sizes (and/or shapes) discussed above. An example of such sizes may include the following:

A=138.4 mm+/−10 mm

B=diameter of 120.1 mm+/−10 mm

C=163.2 mm+/−10 mm

Although the beverage dispensing device 10 has been illustrated as including particular sizes, the beverage dispensing device 10 may have any other size.

FIG. 4 illustrates various views of a beverage vessel 14 of another example beverage dispensing device 10. The beverage vessel 14 of FIG. 4 may be substantially similar to the beverage vessel 14 of FIGS. 1-3; however, the beverage vessel 14 of FIG. 4 may include a specific type of coupling between the beverage vessel 14 and the base 18. For example, as is illustrated in FIG. 4, the beverage vessel 14 may include one or more threads that may allow the beverage vessel 14 to be screwed into the base 18 (e.g., by being screwed into corresponding grooves in the base 18). This may allow the beverage vessel 14 to be more easily uncoupled from the base 18 (so as, for example, to clean the beverage vessel 14).

The beverage vessel 14 of FIG. 4 may have any of the sizes (and/or shapes) discussed above. An example of such sizes may include the following:

D=diameter of 116.3 mm+/−10 mm

E=diameter of 107.3 mm+/−10 mm

F=diameter of 62.4 mm+/−10 mm

G=120.6 mm+/−10 mm

H=55 mm +/−2 mm

I=17 mm+/−2 mm

J=diameter of 54 mm+/−10 mm

K=M62 thread

L=diameter of 70 mm+/−10 mm

Although the beverage vessel 14 has been illustrated as including particular sizes, the beverage vessel 14 may have any other size.

Modifications, additions, or omissions may be made to the beverage dispensing device 10. For example, the filter 38 may be positioned underneath the weighted plug 30, causing the filter 38 to filter the beverage as the liquid passes underneath the weighted plug 30. Furthermore, any of the components and/or functions of any of the beverage dispensing devices 10 of FIGS. 1A-4 may be added to and/or substituted for any of the components and/or functions of any of the other beverage dispensing devices 10 of FIGS. 1A-4.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification. In this manner, Applicant reserves the right to amend the claims during prosecution to add features as variously described in this specification.

What is claimed is:

1. A beverage dispensing device, comprising:
a beverage vessel configured to hold a beverage within the beverage vessel, the beverage vessel having a top portion, a bottom portion, and a hole that extends entirely through the bottom portion of the beverage vessel;
a plug seat located within the beverage vessel and positioned around the hole, the plug seat entirely surrounding the hole, the plug seat further extending into and all the way through the depth of the hole, the plug seat having an opening configured to allow the beverage to flow into the opening, flow through a hollow center of the plug seat, and drain through the hole of the beverage vessel to exit the beverage vessel;
a weighted plug located within the beverage vessel and positioned against the opening in the plug seat, the weighted plug and plug seat being configured to prevent the beverage from draining through the hole by creating a liquid-tight seal, the weighted plug having a connection piece that extends through the hole and securely couples to a first end of a lever;
the lever coupled, at least indirectly, to the beverage vessel, the lever having the first end and a second end positioned distally from the first end, the lever being configured, when activated by pressing vertically downward on the second end, to move the weighted plug vertically upward in relation to the plug seat so as to break the liquid-tight seal and cause the beverage contained in the beverage vessel to flow into the opening, flow through the hollow center of the plug seat, and drain through the hole of the beverage vessel to exit the beverage vessel;
a filter located within the beverage vessel and positioned around the weighted plug, the filter having a mesh screen configured to filter the beverage as the beverage passes through the filter, the filter being shaped as a cylinder with an open end and a closed end, the filter being positioned in one or more grooves formed in the plug seat;
a base coupled to the beverage vessel and configured to hold the beverage vessel in an upright orientation, the base having a handle; and
a lid configured to be positioned on the top portion of the beverage vessel in order to at least partially seal off the top portion of the beverage vessel, the lid being further configured to fit into the base so that the lid can be used as a coaster for the base and beverage vessel.

2. A beverage dispensing device, comprising:
a beverage vessel configured to hold a beverage within the beverage vessel, the beverage vessel having a top portion, a bottom portion, and a hole that extends entirely through the bottom portion of the beverage vessel;
a plug seat located within the beverage vessel and positioned around the hole, the plug seat entirely surrounding the hole, the plug seat having an opening configured to allow the beverage to flow into the opening and drain through the hole of the beverage vessel to exit the beverage vessel;
a weighted plug located within the beverage vessel and positioned against the opening in the plug seat, the weighted plug and plug seat being configured to prevent the beverage from draining through the hole by creating a liquid-tight seal;
a lever coupled, at least indirectly, to the beverage vessel, the lever having a first end and a second end positioned distally from the first end, the lever being configured, when activated, to move the weighted plug in relation to the plug seat so as to break the liquid-tight seal and cause the beverage contained in the beverage vessel to flow into the opening and drain through the hole of the beverage vessel to exit the beverage vessel, wherein the weighted plug is securely coupled to the first end of the lever;
a filter located within the beverage vessel and positioned around the weighted plug, the filter having a mesh screen configured to filter the beverage as the beverage passes through the filter, the filter being positioned in one or more grooves formed in the plug seat;
a base coupled to the beverage vessel and configured to hold the beverage vessel in an upright orientation, the base having a handle; and
a lid configured to be positioned on the top portion of the beverage vessel in order to at least partially seal off the top portion of the beverage vessel.

3. The beverage dispensing device of claim 2, wherein the weighted plug is shaped as a ball and further has a connection piece that extends through the hole and securely couples to the first end of the lever.

4. A beverage dispensing device, comprising:
a beverage vessel configured to hold a beverage within the beverage vessel, the beverage vessel having a hole that extends entirely through a bottom portion of the beverage vessel;
a plug seat located within the beverage vessel and positioned around the hole, the plug seat having an opening configured to allow the beverage to drain through the hole of the beverage vessel to exit the beverage vessel;
a weighted plug located within the beverage vessel and positioned against the opening in the plug seat, the weighted plug and plug seat being configured to prevent the beverage from draining through the hole by creating a liquid-tight seal;
a lever coupled, at least indirectly, to the beverage vessel, the lever being configured, when activated, to move the weighted plug in relation to the plug seat so as to break the liquid-tight seal and cause the beverage contained in the beverage vessel to flow past the opening and drain through the hole of the beverage vessel to exit the beverage vessel, wherein the weighted plug is securely coupled to the lever; and
a filter located within the beverage vessel and positioned around the weighted plug, the filter having a mesh screen configured to filter the beverage as the beverage passes through the filter.

5. The beverage dispensing device of claim 4, wherein the weighted plug and the lever are a single piece.

6. The beverage dispensing device of claim 4, wherein the weighted plug is shaped as a ball and further has a connection piece that extends through the hole and securely couples to an end of the lever.

7. The beverage dispensing device of claim 4, wherein both the weighted plug and an end of the lever are securely coupled to a linkage piece that securely couples the weighted plug to the end of the lever.

8. The beverage dispensing device of claim 4, wherein the plug seat entirely surrounds the hole.

9. The beverage dispensing device of claim 4, wherein the plug seat extends into the hole.

10. The beverage dispensing device of claim 9, wherein the plug seat extends all the way through the depth of the hole.

11. The beverage dispensing device of claim 4, wherein the opening in the plug seat is further configured to allow the beverage to flow into the opening, flow through a hollow center of the plug seat, and drain through the hole of the beverage vessel to exit the beverage vessel.

12. The beverage dispensing device of claim 4, wherein the lever is further configured, when activated, to move the weighted plug vertically upward in relation to the plug seat so as to break the liquid-tight seal and cause the beverage contained in the beverage vessel to flow past the opening and drain through the hole of the beverage vessel to exit the beverage vessel.

13. The beverage dispensing device of claim 4, wherein the lever is further configured, when activated, to move the weighted plug horizontally in relation to the plug seat so as to break the liquid-tight seal and cause the beverage contained in the beverage vessel to flow past the opening and drain through the hole of the beverage vessel to exit the beverage vessel.

14. The beverage dispensing device of claim 4, wherein the lever is configured to be activated by a user moving an end of the lever vertically downward.

15. The beverage dispensing device of claim 4, wherein the lever is configured to be activated by a user moving an end of the lever vertically upward.

16. The beverage dispensing device of claim 4, wherein the lever is configured to be activated by a user moving an end of the lever horizontally.

17. The beverage dispensing device of claim 4, wherein the filter is positioned in one or more grooves formed in the plug seat.

18. The beverage dispensing device of claim 4, further comprising a base coupled to the beverage vessel and configured to hold the beverage vessel in an upright orientation, the base having a handle.

19. The beverage dispensing device of claim 18, wherein the beverage vessel is configured to be screwed into the base to couple the base to the beverage vessel.

20. The beverage dispensing device of claim 4, further comprising a lid configured to be positioned on a top portion of the beverage vessel in order to at least partially seal off the top portion of the beverage vessel.

21. The beverage dispensing device of claim 20, further comprising a base coupled to the beverage vessel and configured to hold the beverage vessel in an upright orientation, wherein the lid is further configured to fit into the base so that the lid can be used as a coaster for the base and beverage vessel.

22. The beverage dispensing device of claim 4, wherein the weighted plug is shaped as a ball and further has a connection piece that extends through the hole and securely couples to an end of the lever, wherein the connection piece is a threaded rod that extends through a hole in the end of the lever, wherein a cap nut securely couples the threaded rod to the end of the lever.
